(19) United States
(12) Patent Application Publication
(10) Pub. No.: US 2008/0273116 A1
(43) Pub. Date: Nov. 6, 2008

(54) Method of Receiving a Multimedia Signal Comprising Audio and Video Frames

(75) Inventor: Philippe Gentric, Fourqueux (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/066,106

(22) PCT Filed: Sep. 8, 2006
(86) PCT No.: PCT/IB2006/053171

§ 371 Date: Mar. 7, 2008

(30) Foreign Application Priority Data
Sep. 12, 2005 (EP) 05300741.5

(51) Int. Cl. H04N 9/475

(52) U.S. Cl. 348/515; 348/E09.034

(57) ABSTRACT

The present invention relates to a method of receiving a multimedia signal in a communication apparatus, said multimedia signal comprising at least a sequence of video frames (VF) and a sequence of audio frames (AF) associated therewith. Said method comprises the steps of: processing (21) and displaying (25) the sequence of audio frames and the sequence of video frames,—buffering (24) audio frames in order to delay them, detecting (22) if the face of a talking person is included in a video frame to be displayed, selecting (23) a first display mode (m1) in which audio frames are delayed by the buffering step in such a way that the sequence of audio frames and the sequence of video frames are synchronized, and a second display mode (m2) in which the sequence of audio frames and the sequence of video frames are displayed without delaying the audio frames, the first display mode being selected if a face has been detected and the second display mode being selected otherwise.

### FIELD OF THE INVENTION

The present invention relates to a method of receiving a multimedia signal on a communication apparatus, said multimedia signal comprising at least a sequence of video frames and a sequence of audio frames associated therewith.

The present invention also relates to a communication apparatus implementing such a method.

Typical applications of the invention are, for example, video telephony (full duplex) and Push-To-Show (half duplex).

### BACKGROUND OF THE INVENTION

Due to the encoding technology, e.g. according to MPEG-4 encoding standard, video encoding and decoding takes more time to process than audio encoding and decoding. This is due to the temporal prediction used in video (both encoder and decoder use one or more images as reference) and to frame periodicity: a typical audio codec produces a frame every 20 ms while video at a rate of 10 frames per second corresponds to a frame every 100 ms.

The consequence is that, in order to maintain a tight synchronization, the so called lip-sync, it is necessary to buffer the audio frames in the audio/video receiver for a duration equivalent to the additional processing time of the video frames so that audio and video frames are finally rendered at the same time. The way of implementing lip-sync is for example described in the real-time transport protocol RTP (request for comments RFC 3550).

This audio buffering, in turn, causes an additional delay which deteriorates the quality of communication since it is well known that such a delay (i.e. the time it takes to reproduce the signal at the receiver end) must be as small as possible.

### SUMMARY OF THE INVENTION

It is an object of the invention to propose a method of receiving a multimedia signal comprising audio and video frames, which provides a better compromise between audio/video display quality and communication quality.

To this end, the method in accordance with the invention is characterized in that it comprises the steps of:

processing and displaying the sequence of audio frames and the sequence of video frames,

buffering audio frames in order to delay them,

detecting if a video event is included in a video frame to be displayed,

selecting a first display mode in which audio frames are delayed by the buffering step in such a way that the sequence of audio frames and the sequence of video frames are synchronized, and a second display mode in which the sequence of audio frames and the sequence of video frames are displayed without delaying the audio frames, the first display mode being selected if the video event has been detected, the second mode being selected otherwise.

As a consequence, the method in accordance with the invention proposes two display modes: a synchronized lip-sync mode (i.e. the first mode) and a non-synchronized mode (i.e. the second mode), the synchronized mode being selected when a relevant video event has been detected (e.g. the talking person face), namely when a tight synchronization is truly required.

According to an embodiment of the invention, the detecting step includes a face recognition and tracking step. Beneficially, the face recognition and tracking step comprises a lip motion detection sub-step which discriminates if the detected face is talking. Additionally, the face recognition and tracking step further comprises a sub-step of matching the lip motion with the audio frames. The face recognition and tracking step may be based on skin color analysis. The buffering step may comprise a dynamic adaptive audio buffering sub-step in which, when going from the first display mode to the second display mode, the display of the audio frames is accelerated so that the amount of buffered audio data is reduced.

The present invention also extends to a communication apparatus for receiving a multimedia signal comprising at least a sequence of video frames and a sequence of audio frames associated therewith, said communication apparatus comprising:

a data processor for processing and displaying the sequence of audio frames and the sequence of video frames,

a buffer for delaying audio frames,

signaling means for indicating if a video event is included in a video frame to be displayed,

the data processor being adapted to select a first display mode in which audio frames are delayed by the buffer in such a way that the sequence of audio frames and the sequence of video frames are synchronized, and a second display mode in which the sequence of audio frames and the sequence of video frames are displayed without delaying the audio frames, the first display mode being selected if the video event has been signaled, the second mode being selected otherwise.

According to an embodiment of the invention, the signaling means comprise two cameras and the data processor is adapted to select the display mode in dependence on the camera which is in use.

According to another embodiment of the invention, the signaling means comprise a rotary camera and the data processor is adapted to select the display mode in dependence on a position of the rotary camera.

Still according to another embodiment of the invention, the signaling means are adapted to extract the display mode to be selected from the received multimedia signal.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a communication apparatus in accordance with an embodiment of the invention;

FIG. 2 is a block diagram of a method of receiving a multimedia signal comprising audio and video frames in accordance with the invention.

### DETAILED DESCRIPTION OF THE INVENTION

The present invention relates to a method of and an apparatus for receiving a bit stream corresponding to a multimedia data content. This multimedia data content includes at least a sequence of video frames and a sequence of audio frames associated therewith. Said sequences of video frames and audio frames have been packetized and transmitted by a data content server. The resulting bit stream is then processed (e.g. decoded) and displayed on the receiving apparatus.

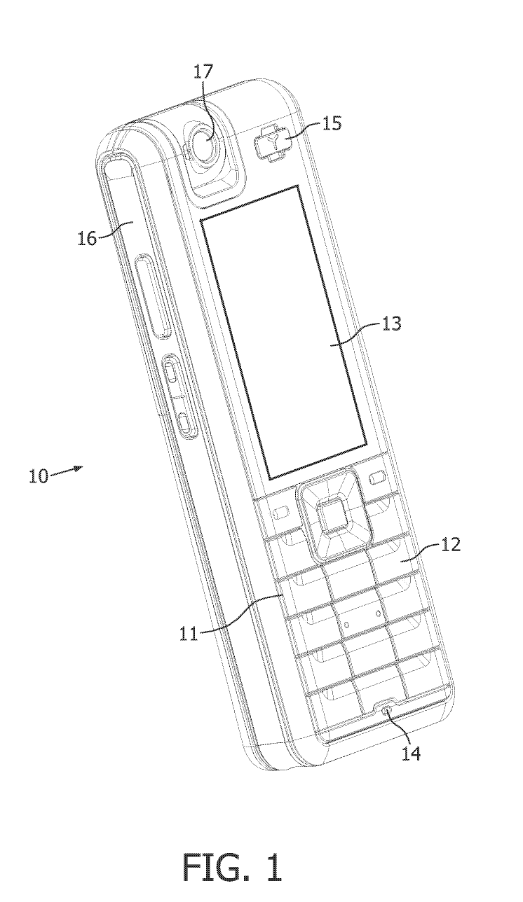

Referring to FIG. 1 of the drawings, a communication apparatus 10 according to an exemplary embodiment of the present invention is depicted. This communication apparatus is either a cordless phone or a mobile phone. However, it will be apparent to a person skilled in the art that the communication apparatus may be another apparatus such a personal digital assistant (PDA), a camera, etc. The cordless or mobile phone comprises a housing 16 including a key entry section 11 which comprises a number of button switches 12 for dial entry and other functions. A display unit 13 is disposed above the key entry section 11. A microphone 14 and a loudspeaker 15, located at opposite ends of the phone 10, are provided for receiving audio signals from the surrounding area and transmitting audio signal coming from the telecommunications network, respectively.

A camera unit 17, the outer lens of which is visible, is incorporated into the phone 10, above the display unit 13. This camera unit is capable of capturing a picture showing information about the callee, for example his face. In order to achieve such a video transmission/reception, the phone 10 comprises audio and video codecs, i.e. encoders and decoders (not represented). As an example, the video codec is based on the MPEG4 or the H.263 video encoding/decoding standard. Similarly, the audio codec is based, for example, on the MPEG-AAC or G.729 audio encoding/decoding standard. The camera unit 17 is rotary mounted relative to the housing 16 of the phone 10. Alternatively, the phone may comprise two camera units on opposite sides of the housing.

The communication apparatus according to the invention is adapted to implement at least two different display modes:

a first display mode hereinafter referred to as “lip-sync mode” according to which a delay is put on the audio path in order to produce perfect synchronization between audio and video frames;

a second display mode hereinafter referred to as “fast mode” according to which no additional delay is put on the audio processing path.

This second mode results in a better communication from a delay management point of view, but the lack of synchronization can be a problem, especially when the face of a talking person is on a video frame.

The present invention proposes a mechanism for automatically switching between the lip-sync mode and the fast mode. The invention is based on the fact that a tight synchronization is mainly required when the video frame displays the face of the person who is talking in a conversation. This is the reason why tight synchronization is called “lip-sync”. Because the human brain uses both audio and lip reading to understand the speaker, it is extremely sensitive to audio-video split between the sound and the lip motions.

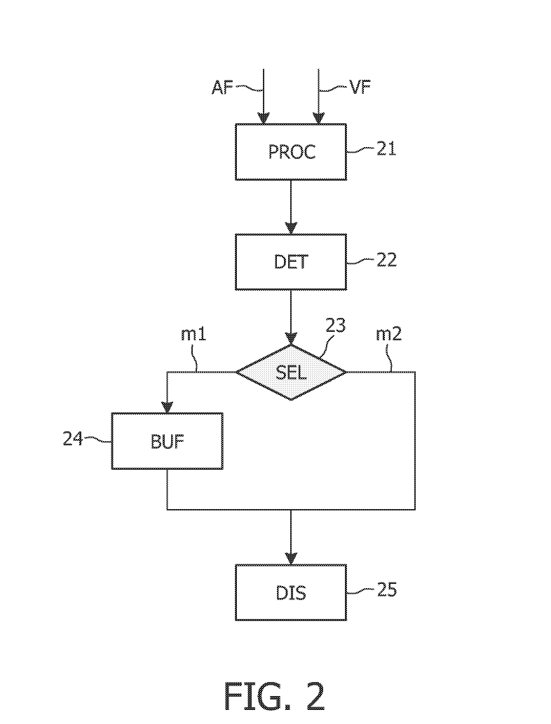

Referring to FIG. 2 of the drawings, the method in accordance with the invention comprises a processing step PROC (21) for extracting the audio and video signals and for decoding them.

It also comprises a detection step DET (22) in order to check if there is the face of a talking person in a video frame to be displayed.

If such a face is detected, the lip-sync mode m1 is selected during a selection step SEL (23); if not, the fast mode m2 is selected.

If the lip-sync mode m1 is selected, the audio frames are delayed by a buffering step BUF (24) in such a way that the sequence of audio frames and the sequence of video frames are synchronized.

Finally, the sequence of audio frames and the sequence of video frames are displayed during a displaying step DIS (25).

The detection step is based, for example, on existing face recognition and tracking techniques. These techniques are conventionally used, for example, for automatic camera focusing and stabilization/tracking and it is here proposed to use them in order to detect if there is a face in a video frame.

According to an example, the face detection and tracking step is based on skin color analysis, where the chrominance values of the video frame are analyzed and where skin is assumed to have a chrominance value lying in a specific chrominance range. In more detail, skin color classification and morphological segmentation is used to detect a face in a first frame. This detected face is tracked over subsequent frames by using the position of the faces in the first frame as a marker and detecting for skin in the localized region. Specific advantages of this approach are that skin color analysis method is simple and powerful. Such a face detection and tracking step is described, for example, in “Human Face Detection and Tracking using Skin Color Modeling and Connected Component Operators”, P. Kuchi, P. Gabbur, P. S. Bhat, S. David, IETE Journal of Research, Vol. 38, No. 3&4, pp. 289-293, May-Aug 2002.

According to another example, the face detection and tracking step is based on dynamic programming. In this case, the face detection step comprises a fast template matching procedure using iterative dynamic programming in order to detect specific parts of a human face such as lip, eyes, nose or ears. The face detection algorithm is designed for frontal face but can also be applied to track non-frontal faces with online adapted face models. Such a face detection and tracking step is described, for example, in “Face detection and tracking in video using dynamic programming”, Zhu Liu and Yao Wang, ICIP00, Vol I: pp. 53-56, October 2000.

It will apparent to a skilled person that the present invention is not limited to the above described face detection and tracking step and can based on other approach such as, for example, a neural network based approach.

Beneficially, the face detection and tracking step is able to provide a likelihood that the detected face is talking. To this end, said face detection and tracking step comprises a lip motion detection sub-step that can discriminate if the detected face is talking. Additionally, the lip motion can be matched with the audio signal, in which case a positive identification that the face in the video is the person talking can be made. To this end, the lip motion detection sub-step is able to read the lips, partially or completely, and to check by matching the lip motions with the audio signal if the person in the video is the one who is talking.

Such a lip motion detection sub-step is based, for example on dynamic contour tracking. In more detail, the lip tracker that uses a Kalman filter based dynamic contour to track the outline of the lips. Two alternative lip trackers might be used, one for tracking lips from a profile view and the other from a frontal view, which lip trackers are adapted to extract visual speech recognition features from the lip contour. Such a lip motion detection sub-step is described, for example, in “Real-Time Lip Tracking for Audio-Visual Speech Recognition Applications” by Robert Kaucic, Barney Dalton, and Andrew Blake, in Proc. European Conf. Computer Vision, pp. 376-387, Cambridge, UK, 1996.

The selection of the display mode (i.e. lip sync mode or fast mode) to be selected has been described in the context of face detection and tracking. However, it will be apparent to a skilled person that the invention is by no way limited to this particular embodiment. For example, the way of detecting the display mode to be selected may be based on the detection of the camera which is in use for apparatuses (e.g. phones) that have two cameras, one camera facing toward the user, one camera facing the other way. Alternatively, the way of detecting the display mode to be selected is based on the rotation angle of the camera for apparatuses that include only one camera that can be rotated and means for detecting the rotation angle of the rotary camera.

According to another embodiment of the invention, the detection can be made at the sender side, and the sender can signal that it is transmitting a video sequence that should be rendered in the lip-sync mode. This is advantageous in one-to-many communication where the burden of computing the face detection is for the sender only, thereby saving resources (battery life, etc) for possibly many receivers. To this end, the multimedia bit stream to be transmitted includes in addition to the audio and video frames, a flag indicating which mode should be used for the display of the multimedia content on the receiver. Another advantage of doing the detection at the sender side is to combine it with camera stabilization and focusing, which is a must for handheld devices such as mobile videophone.

It is to be noted that, if the detection is made at the receiver side, it can be an additional feature which is available with a manual override and user preferences.

In order to maintain the end-to-end delay as short as possible the method in accordance with an embodiment of the invention comprises a dynamic adaptive audio buffering step. The audio buffer is kept as small as possible according to the constraint that the network jitter may cause the buffer to underflow, which produces audible artifacts. This is only possible in the fast mode, since it requires having a way of changing the pitch of the voice to play faster or slower than real time. An advantage of this particular embodiment of the invention is that this dynamic buffer management can be used to manage the transition between the display modes, specifically:

when going from the fast mode to the lip-sync mode, the play back of the voice is slowed so that audio data accumulate in the buffer;

when going from the lip-sync mode to the fast mode, the play back of the voice is faster than real-time so that the amount of audio data in the buffer is reduced.

The invention has been described above in the context of the selection of two display modes but it will be apparent to a skilled person that additional modes can be provided. For example, a third mode referred to as “slow mode” can be used. Said slow mode corresponds to an additional post-processing based on the so-called “Natural Motion”, according to which a current video frame at time t is interpolated from a past video frame at time t−1 and a next video frame at time t+1. Such a slow mode improves the video quality but increases the delay between audio and video. Thus, this third mode is more adapted to situation where the face of the talking person is not present in the video frames to be displayed.

The invention has been described above in the context of the detection of a talking person face but it will be apparent to a skilled person that the principle of the invention can be generalized to the detection of other video events provided that a tight synchronization is required between a sequence of video frames and a sequence of audio frames in response to the detection of such a video event. As an example, the video event may correspond to several persons singing in a chorus, dancing according to a given music, or clapping in their hands. In order to be detected, the video events need to be periodical or pseudo-periodical. Such a detection of periodical video event is described, for example, in the paper entitled “Efficient Visual Event Detection using Volumetric Features”, by Yan Ke, Rahul Sukthankar, Martial Hebert, iccv2005. In more detail, this paper studies the use of volumetric features as an alternative to popular local descriptor approaches for event detection in video sequences. To this end, the notion of 2 D box features is generalized to 3 D spatiotemporal volumetric features. A real-time event detector is thus constructed for each action of interest by learning a cascade of filters based on volumetric features that efficiently scans video sequences in space and time. The event detector is adapted to the related task of human action classification, and is adapted to detect actions such as hand clapping.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa.

The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of receiving a multimedia signal in a communication apparatus, said multimedia signal comprising at least a sequence of video frames and a sequence of audio frames associated therewith, said method comprising the steps of:
processing and displaying the sequence of audio frames and the sequence of video frames,
buffering audio frames in order to delay them,
detecting if a video event is included in a video frame to be displayed,
selecting a first display mode in which audio frames are delayed by the buffering step in such a way that the sequence of audio frames and the sequence of video frames are synchronized, and a second display mode in which the sequence of audio frames and the sequence of video frames are displayed without delaying the audio frames, the first display mode being selected if a video event has been detected, the second mode being selected otherwise.

2. A method as claimed in claim 1, wherein the detecting step includes a face recognition and tracking step.

3. A method as claimed in claim 2, wherein the face recognition and tracking step comprises a lip motion detection sub-step which discriminates if the detected face is talking.

4. A method as claimed in claim 3, wherein the face recognition and tracking step further comprises a sub-step of matching the lip motion with the audio frames.

5. A method as claimed in claim 2, wherein the face recognition and tracking step is based on skin color analysis.

6. A method as claimed in claim 1, wherein the buffering step comprises a dynamic adaptive audio buffering sub-step in which, when going from the first display mode to the second display mode, the display of the audio frames is accelerated so that the amount of buffered audio data is reduced.

7. A communication apparatus receiving a multimedia signal comprising at least a sequence of video frames and a sequence of audio frames associated therewith, said communication apparatus comprising:
a data processor for processing and displaying the sequence of audio frames and the sequence of video frames,
a buffer for delaying audio frames,
signaling means for indicating if a video event is included in a video frame to be displayed,
the data processor being adapted to select a first display mode in which audio frames are delayed by the buffer in such a way that the sequence of audio frames and the sequence of video frames are synchronized, and a second display mode in which the sequence of audio frames and the sequence of video frames are displayed without delaying the audio frames, the first display mode being selected if the video event has been signaled, the second mode being selected otherwise.

8. A communication apparatus as claimed in claim 7, wherein the signaling means comprise two cameras and wherein the data processor is adapted to select the display mode in dependence on the camera which is in use.

9. A communication apparatus as claimed in claim 7, wherein the signaling means comprise a rotary camera and wherein the data processor is adapted to select the display mode in dependence on a position of the rotary camera.

10. A communication apparatus as claimed in claim 7, wherein the signaling means are adapted to extract the display mode to be selected from the received multimedia signal.

11. A communication apparatus as claimed in claim 7, wherein the signaling means comprise face recognition and tracking means.
